(19) United States
(12) Patent Application Publication
(10) Pub. No.: US 2007/0107787 A1
(43) Pub. Date: May 17, 2007

(54) Rotary shift valve for automatic transmission systems

(75) Inventor: R. Dale Moretz, Jackson, MI (US)

Correspondence Address: YOUNG & BASILE, P.C., 3001 WEST BIG BEAVER ROAD, SUITE 624, TROY, MI, 48084, US

(73) Assignee: MORETZ TECHNOLOGY, LLC

(21) Appl. No.: 11/601,149

(22) Filed: Nov. 17, 2006

Related U.S. Application Data
(60) Provisional application No. 60/737,550, filed on Nov. 17, 2005.

(51) Int. Cl. F16K 11/074

(52) U.S. Cl. 137/625.11

(57) ABSTRACT

The specification discloses a valve for selectively porting a fluid through one or more outlets, the valve comprising: a housing having an exterior, an interior cavity, and at least one outlet passageway defined through the housing, the outlet passageway communicating the interior cavity to the exterior of the housing through an outlet opening; an inner member disposed within the interior cavity of the housing and selectively moveable relative thereto, the inner member having an exterior, an interior cavity for holding a fluid, and at least one outlet passageway defined through the inner member and communicating the interior cavity to the exterior of the inner member through an outlet opening; and at least one inlet passageway defined through each of the inner member and the housing for communicating a fluid from outside the housing to the interior cavity of the inner member. By selective movement of the inner member relative to the housing, the at least one outlet passageway and outlet opening of the inner member may be brought into communication with the at least one outlet passageway defined through the housing to thereby permit communication of a fluid from the interior cavity of the inner member to the exterior of the housing via the communicating outlet passageways.

### CROSS-REFERENCE TO RELATED APPLICATIONS

This application is related to, and claims the benefit of priority from, Provisional Application Ser. No. 60/737,550, filed Nov. 17, 2005.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### FIELD OF THE INVENTION

The present invention relates to the field of valves for selectively porting a fluid through one or more outlets, and more particularly to such a valve comprising a housing having an interior cavity in which is rotatably disposed an inner member having an interior cavity for holding a fluid. The inner member is selectively rotatable relative to the housing to selectively bring at least one outlet passageway defined therethrough into communication with at least one passageway defined through the housing, thus permitting selective communication of a fluid from the interior cavity of the inner member to the exterior of the housing, and thence to one or more downstream elements which may be actuated by such fluid.

### BACKGROUND OF THE INVENTION

Automatic transmissions are apparatus used to change the gearing ratios between an engine and the drive axles in a motor vehicle, in order to provide the torque needed to start the vehicle from a stop, accelerate the vehicle from a slower speed to a faster speed, or to enable the vehicle to climb grades or carry or tow heavy loads, as well as to provide ratios needed for the vehicle to attain and maintain higher speeds and to realize desirable fuel economy, engine noise levels, and to minimize engine wear.

Automatic transmissions function through clutches which are activated or deactivated by the application, through a shift valve, of hydraulic pressure to activators for the appropriate clutches. The shift valve is itself controlled by a computer controller, and/or by a system of sensors and relays, which switch power between several electromagnets. In the typical shift valve, these electromagnets attract and/or repel ferrous spools to either end of a clylindrical bore in the shift valve body. Each such bore intersects with other bores, allowing hydraulic fluid to be directed through one or more ports to activate one or more clutches, depending on whether the spool has been attracted/repelled to a position covering an intersection between the valve bore and another, adjoining bore, or to a position away from such an intersection.

Exemplary of the foregoing types of transmissions are the disclosures of Asano et al., U.S. Pat. No. 3,707,891, and Sugano, U.S. Pat. No. 4,566,355, which disclosures are incorporated herein by reference in their entireties.

Unfortunately, automatic transmission shift valves of such conventional construction are attended by several considerable drawbacks. First, the size of the aluminum block required to accommodate the numerous bores needed for a typical transmission, and the electromagnetic coils required for activation (typically two electromagnets for each spool), makes these shift valves both very heavy and quite large in terms of total space required within the engine envelope. Second, in order for the shift valve to function without excessive leakage, the bores and the ferrous spools which reside therein must be very straight, cylindrical and smooth. Likewise, the manufacturing and operating tolerances of these components must be very narrow. In addition to requiring very precise manufacturing methods and procedures, the close operating tolerances also make such conventional shift valves extremely sensitive to any contamination; the presence of even very small particulates can interfere with the movement of the ferrous spools inside the bores, thus hindering or even preventing operation of the valve. In order to assure proper shift valve operation, very thorough filtration of the hydraulic fluid is thus conventionally required, and most failures of typical shift valves involve tiny particulates which escape filtration and are caught between a spool and a bore.

It would thus be advantageous to have an automatic transmission in which the shift valve thereof was at once relatively small and lightweight, and which required less stringent tolerances between the operating components thereof.

### SUMMARY OF THE DISCLOSURE

The present invention encompasses improvements to the prior art by providing a valve for selectively porting a fluid through one or more outlets, the valve comprising a housing having an exterior, an interior cavity, and at least one outlet passageway defined through the housing. The outlet passageway communicates the interior cavity to the exterior of the housing through an outlet opening. The inventive valve further includes an inner member disposed within the interior cavity of the housing and selectively moveable relative thereto, the inner member having an exterior, an interior cavity for holding a fluid, and at least one outlet passageway defined through the inner member and communicating the interior cavity to the exterior of the inner member through an outlet opening. To communicate a fluid from outside the housing to the interior cavity of the inner member, there is further provided at least one inlet passageway defined through each of the inner member and the housing. By selective movement of the inner member relative to the housing, the at least one outlet passageway and outlet opening of the inner member may be brought into (and out of) communication with the at least one outlet passageway defined through the housing, thereby permitting selective communication of a fluid from the interior cavity of the inner member to the exterior of the housing via the communicating outlet passageways.

According to one embodiment of the present invention, the at least one outlet opening of the inner member is characterized by a varying geometry. By selective movement of the inner member relative to the housing, the at least one outlet opening of the inner member may be brought into communication with the at least one outlet passageway defined through the housing in a plurality of orientations, each of which permits a different rate of fluid flow from the interior cavity of the inner member to the exterior of the housing via the communicating outlet passageways.

In another embodiment, the at least one outlet opening of the inner member and the at least one outlet passageway of the inner member are characterized by generally constant geometries. By selective movement of the inner member relative to the housing, the at least one outlet opening of the inner member may be brought into communication with the at least one outlet passageway defined through the housing in single orientation which permits a relatively constant rate of fluid flow from the interior cavity of the inner member to the exterior of the housing via the communicating outlet passageways.

According to another feature of the present invention, at least one raised projection is provided on the exterior of the inner member, the at least one outlet opening of the inner member being defined in the at least one raised projection.

Per yet another aspect of the instant invention, the inner member may be elastically expandable radially outwardly under the pressure of a fluid disposed in the inner member interior cavity so as to bring the at least one raised projection into sealing contact with the housing.

### BRIEF DESCRIPTION OF THE DRAWINGS

These and other features of the instant invention will be better understood with reference to the following description and accompanying drawings, of which:

FIG. 1 is an exploded perspective view of the valve of the present invention according to a first embodiment thereof;

FIG. 2 is a partial cut away, perspective view of the valve of the present invention;

FIG. 3 is an exploded perspective view of the housing portion of the valve of the present invention, according to a second embodiment thereof;

FIG. 4 is a detailed cross-sectional view depicting the inventive valve of one embodiment thereof under operating conditions, wherein the inner member is rotated to bring an outlet opening and associated outlet passageway thereof into alignment with an outlet passageway defined through the housing portion;

FIG. 5 is a detailed cross-sectional view depicting one alternative arrangement for communicating a fluid to the interior cavity of the inner member of the inventive valve;

FIG. 6 is an exploded perspective view of the inner member of the valve of the present invention, according to a second embodiment thereof;

FIG. 7 is an exploded perspective view of the inner member of the valve of the present invention, according to a third embodiment thereof;

FIG. 8 is a detailed perspective view of an alternative configuration of the inner member outlet opening;

FIGS. 9 and 10 are detailed cross-sectional views illustrating exemplary operation of the outlet passageways and outlet opening of the alternative configuration of FIG. 8;

FIG. 11 is an exploded perspective view of the valve of the present invention according an alternative embodiment thereof incorporating the outlet openings of FIG. 8;

FIG. 12 is a perspective view of an alternative embodiment of the inventive valve, according to which at least one pair of outlet openings are provided in longitudinal alignment to effect the simultaneous porting of a fluid through plural outlet passageways;

FIG. 13 is a detailed cross-sectional view of an inventive valve according to one embodiment thereof, wherein means are provided for directing a lubricant between the inner member and the housing portion; and

FIG. 14 is a schematic representation of the present invention in an operational environment wherein the inventive valve functions as a shift valve for a motor vehicle automatic transmission.

### WRITTEN DESCRIPTION

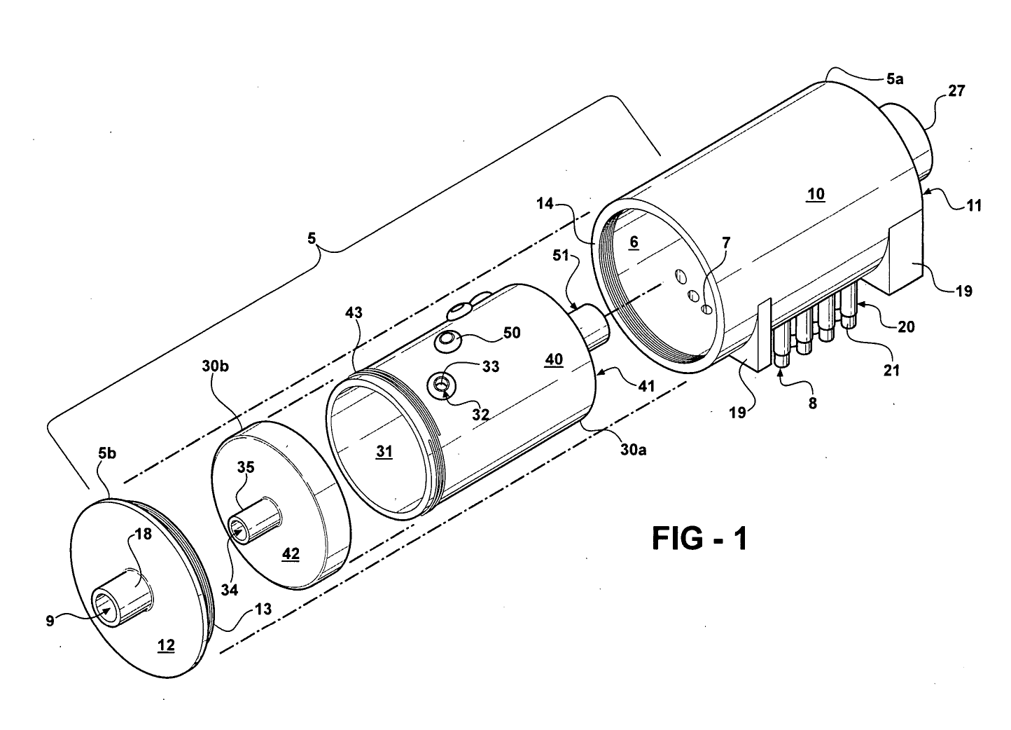

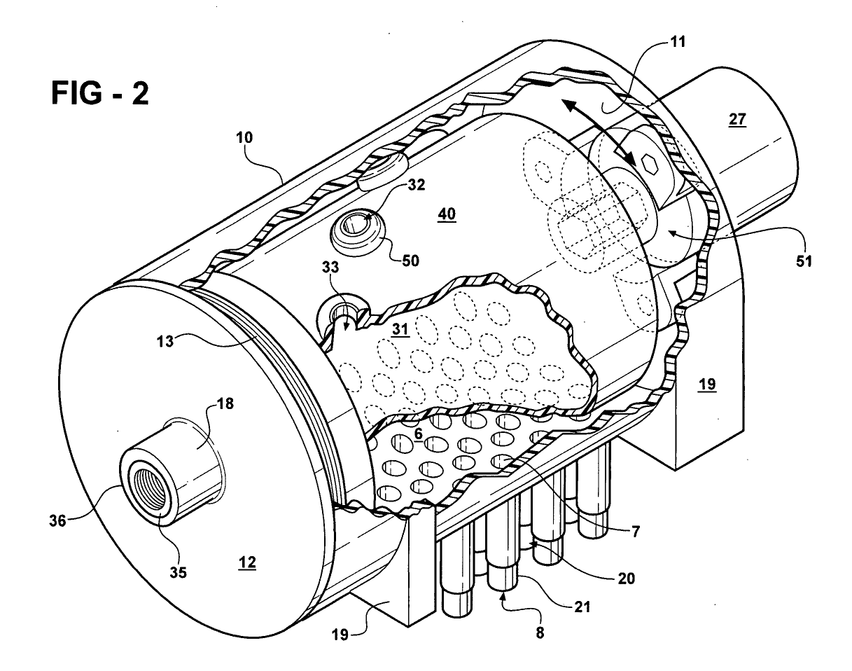

Referring now to the drawings, and more specifically to FIGS. 1 and 2, the present invention will be seen to generally comprise, in a first exemplary embodiment thereof, a valve for selectively porting a fluid through one or more outlets, and thence to one or more downstream elements which may be actuated by such fluid (including, for instance, clutches), the valve including: First, a housing 5 having an interior cavity 6, and at least one passageway 7 defined through the housing 5, such passageway 7 communicating the interior cavity 6 (FIG. 2) through at least one outlet opening (indicated generally at 8) to the exterior of the housing 5; and, second, an inner member 30 moveably disposed within the interior cavity 6 of the housing 5 and selectively moveable relative to the housing 5, the inner member 30 having an interior cavity 31 for holding a fluid, such as, for instance, hydraulic fluid for an automatic transmission system, and at least one passageway 32 defined through the inner member 30 and communicating the interior cavity 31 of the inner member through at least one outlet opening 33 to the exterior of the inner member 30. Such a valve as disclosed herein is especially, though not exclusively, suited for operation as a shift valve for a motor vehicle automatic transmission.

With continuing reference being had to FIGS. 1 and 2, at least one inlet passageway 9 and 34 is further defined through each of the housing 5 and inner member 30, respectively, for communicating a fluid to the interior cavity 31 of the inner member 30, as described in greater detail hereinbelow. Such passageways may, according to this first illustrated embodiment of the present invention, be defined coaxial with each other and the longitudinal axis of the valve. However, such configuration is not intended to be limiting of the inventive valve, and other inlet passageway configurations are thus contemplated, including, as explained further herein, inlet passageways extending radially through the housing 5 and inner member 30.

Referring specifically to FIG. 1, housing 5 is, according to the illustrated embodiment, at least a two-part structure comprising a first housing portion 5a having a generally cylindrically-shaped wall 10 terminating at one longitudinal end in an end wall 11, and terminating oppositely in an open end over which is secured a second housing portion 5b in the form of a cap or cover defining a further end wall 12 to thus close the housing 5 and define the cavity 6 interiorly thereof.

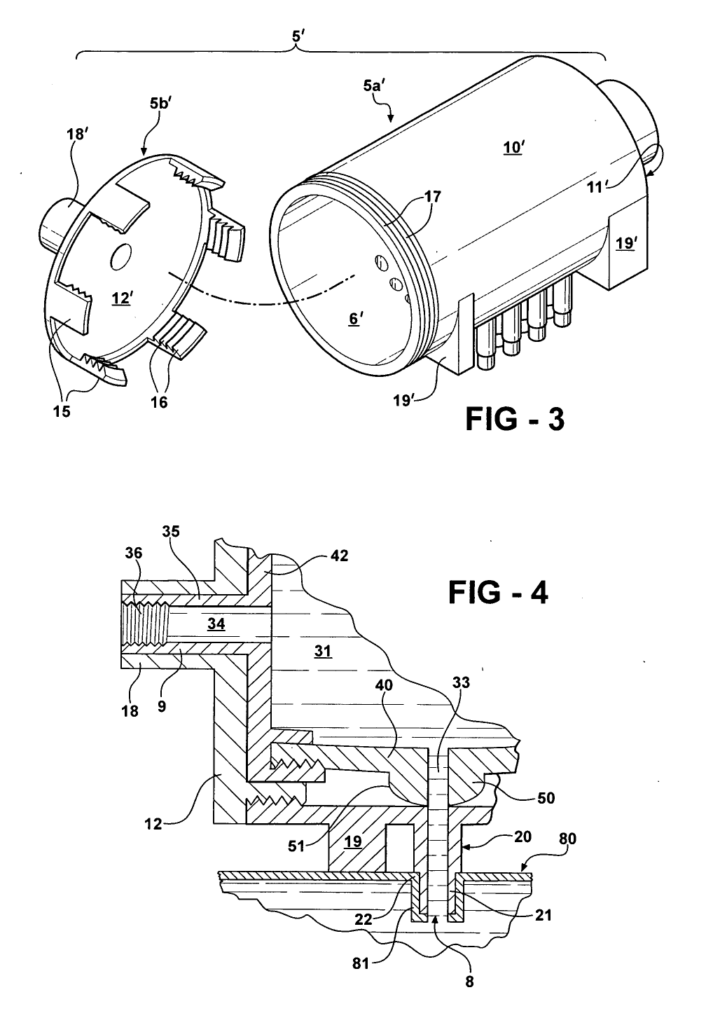

According to this first embodiment, the second housing portion 5bincludes external threads 13, so as to permit threading securement to the correspondingly threaded 14 interior surface of the wall 10 proximate the open end of the first housing portion 5a. However, such manner of attachment of the second housing portion 5bto the first housing portion 5a is not intended to be limiting of the invention and, according to a second embodiment of the housing shown in FIG. 3, second housing portion 5b′ may be press-fit into engagement with the first housing portion 5a′. More particularly, second housing portion 5b′ of this alternate embodiment comprises a plurality of projections 15 spaced apart about the circumference of the housing portion 5b′ end wall 12′, each such projection 15 extending in a first direction from the plane of the end wall 12′. Each projection 15 includes a plurality of teeth 16 arranged seriatim along the length thereof and projecting radially inwardly towards the center of the second housing portion 5b′. The teeth 16 are each engageable with one of a plurality of annular grooves 17 defined about the exterior circumference of the first housing portion 5a′ wall 10′, each such groove having a cross-sectional shape complimentary to the cross-sectional shape of the teeth 16. According to the illustrated embodiment, the teeth 16 and grooves 17 are characterized by a “buttress thread” type cross-sectional shape.

According to either of the foregoing embodiments, the second housing portions 5b, 5b′ will be seen to include a stem 18, 18′, respectively, extending from the end wall 12, 12′ thereof and arranged coaxial with the longitudinal axis of the housing 5, 5′. The stem comprises a cylindrical member through which extends the passageway 9, 9′.

Referring specifically to the embodiment of FIGS. 1 and 2 as being exemplary of the others in these regards, except as otherwise noted, the passageway 9 is dimensioned to rotatably receive therein a corresponding stem 35 of the inner member 30, with such stem of the inner member being adopted for securement to an external fluid supply, such as through the illustrated threads 36, for instance, so as to communicate a fluid through passageway 34 to the interior cavity 31 of the inner member 30. These means of communicating a fluid to the inner member may be eliminated in favor of other means including, as described further hereinbelow, the provision of radial ports provided through the housing and communicating a fluid to one or more radial channels disposed on the exterior of the inner member which convey the fluid through one or more ports therein to the interior cavity of the inner member.

As shown in the various illustrated embodiments, with the embodiment of FIGS. 1 and 2 being representative, the housing 5 of the present invention is characterized by a generally cylindrical shape, wherein the exterior of the housing 5 and the interior cavity 6 are both substantially defined by the same cylindrically shaped wall 10 of the housing 5. Of course, it is contemplated that the exterior shape of the housing 5 may be other than cylindrical, subject to user need or desire; only the interior cavity 6 needs to be generally cylindrical. Similarly, it will be appreciated from this disclosure that the inner member need not be limited to the generally cylindrical shape herein described.

Referring now to FIGS. 1, 2, and 4, in order to permit the outer housing 5 to be mated to a manifold or distribution channel system of the type commonly incorporated into many transmission systems, housing 5, and, more specifically, first housing portion 5a of the illustrated valve further includes a base comprising spaced-apart supports 19 having disposed therebetween at least one (and, as depicted, a plurality of) radially projecting conduit 20 defining a portion of the passageway 7 through the housing 5 and communicating the interior cavity 6 thereof with the outlet opening 8 defined proximate the end of each such conduit 20. The terminal portion 21 of each such conduit 20 is further characterized by a narrower outside diameter than that of the remainder of the conduit 20, such narrower diameter terminal portions 21 each being dimensioned to be received within a corresponding outlet opening 81 provided on a manifold 80 (see FIG. 4). Sealing means, including, by way of non-limiting example, O-rings 22, may be provided on each such terminal portion 21 to ensure sealing engagement between each terminal portion 21 and the corresponding manifold outlet into which it is received.

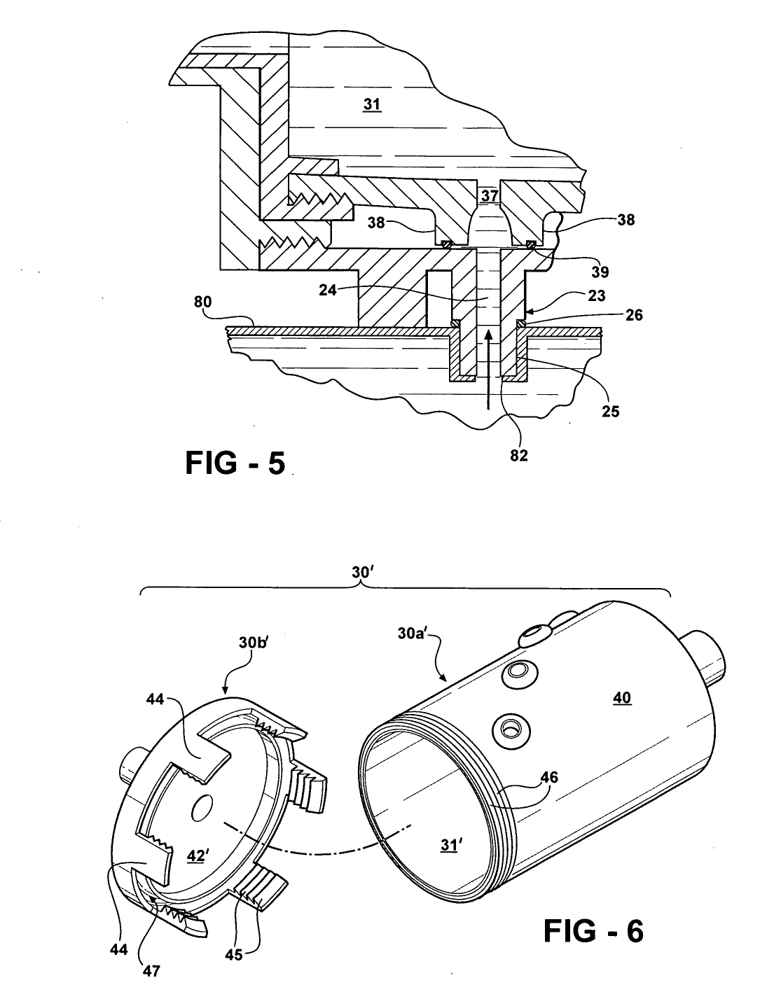

Referring also to FIG. 5, the foregoing base arrangement may also provide an alternative means for supplying a fluid to the interior cavity 31 of the inner member 30. According to this arrangement, the manifold base includes at least one radially projecting inlet conduit 23 comprising a fluid inlet passageway 24 defined through the housing 5 and communicating a fluid from the manifold 80 to the interior cavity 31 of the inner member 30 via an annular groove or channel 37 defined on the exterior surface of the inner member 30 by a pair of spaced-apart, parallel annular ridges 38. The ridges 38 are sealingly engaged with the inner surface of the housing wall 10, for instance by means of O-rings 39 provided on each ridge 38. The inlet conduit 23 includes, as shown, a terminal portion 25 characterized by a narrower outside diameter than that of the remainder of the conduit 23, such narrower terminal portion 25 being dimensioned to be received within a corresponding inlet opening 82 provided on the manifold 80. Sealing means, including, by way of non-limiting example, an o-ring 26, may be provided on such terminal portion 25 to ensure sealing engagement between the terminal portion 25 and the corresponding manifold inlet 82 into which it is received.

Of course, the aforedescribed embodiments comprehend only exemplary means for connecting the valve of the present invention to a fluid supply and/or downstream elements (e.g., clutches) actuated by the inventive valve, and other such means are certainly possible and will be appreciated by those of skill in the art having the benefit of this disclosure. Those skilled in the art will appreciate that other mating interfaces may be mandated by the configuration of the manifold or channel distribution system to which the inventive device is to be connected. Thus, for instance, it is envisioned that the housing may constitute a planar bottom comprising a plurality of openings therein which communicate with corresponding openings in a manifold or channel distribution system, these corresponding openings being sealed with gaskets or the like in a compression sealing arrangement.

With continuing reference to FIGS. 1 and 2 specifically, housing 5 includes a mount 27 provided on and extending from the end wall 11 for supporting manual, such as a lever, cam, etc. (not shown), or automatic, such as a motor (not shown), actuation means. Without limitation, exemplary motors may comprise a stepper motor, variable solenoid, or servo motor operative to incrementally rotatably move the inner member 30 relative to the housing 5. Of course, those skilled in the art will appreciate that various means, both manual and automatic, may be employed to drive the selective rotational movement of the inner member 30, and that such desired means may be both arranged relative to the housing 5 and operatively coupled to the inner member 30 in numerous ways, depending upon such considerations as the type of actuation means employed.

According to the several embodiments of the housing 5 as described hereinabove, the one or more components thereof may be formed from any suitably strong and rigid materials, including, by way of non-limiting example, metals such as aluminum, zinc, or magnesium, rigid polymers, including, for instance, reinforced (such as, for example, with fiberglass or carbon fiber) polymers. Relatedly, these one or more components may be formed by any conventional means, including, for instance, die-casting.

Still referring to FIGS. 1 and 2, the inner member 30, according to a first exemplary embodiment, is shown as at least a two-part structure comprising a first inner member portion 30a having a generally cylindrically-shaped wall 40 terminating at one longitudinal end in an end wall 41, and terminating oppositely in an open end over which is secured a second inner member portion 30b in the form of a cap or cover defining a further end wall 42 to thus close the inner member 30 and define the cavity 31 interiorly thereof. This second inner member portion 30b may be internally threaded (not visible) for threaded engagement with complimentary threads 43 provided on the exterior of cylindrical wall 40 proximate the open end of the first inner member portion 30a.

However, such manner of attachment of the second inner member portion 30b to the first inner member portion 30a is not intended to be limiting of the invention and, according to a second embodiment of the inner member 30′, shown in FIG. 6, the second inner member portion 30b′ may be press-fit into engagement with the first inner member portion 30a′. More particularly, the second inner member portion 30b′ of this alternate embodiment comprises a plurality of spaced apart projections 44 arranged about the circumference of the second inner portion 30b′ end wall 40′ and extending in a first direction from the plane of the end wall 40′. Each such projection 44 includes a plurality of teeth 45 arranged seriatim along the length thereof and projecting radially inwardly towards the center of the second inner member portion 30b′. The teeth 45 are each engageable with one of a plurality of annular grooves 46 defined about the exterior circumference of the cylindrical wall 38′ of the first inner member portion 30a′, each such groove having a cross-sectional shape complimentary to the cross-sectional shape of the teeth 45.

Still referring to FIG. 6, the second inner member portion 30b′ includes an annular channel 47 defined by a pair of spaced-apart, concentric annular walls. The annular channel 47 is arranged so as to oppose the opening on the first inner member portion 30a′, and is dimensioned receive therein the end of the cylindrical wall 40′ of the first inner member portion 30a′. To ensure sealing securement of first 30a′ and second 30b′ inner member portions, sealing means such as, for example, an O-ring (not shown) may be disposed inside the annular channel 47.

In yet another embodiment, shown in FIG. 7, the second inner member portion 30b″ is welded, such as, for example, by spin-welding, sonic welding, etc., or otherwise adhered to the end of the first inner member portion 30a″ proximate the opening therein. More particularly, the second inner member portion 30b′ according to this embodiment comprises a pair of spaced-apart, concentric annular walls 48a, 46b extending in a first direction from the plane of the end wall 40″, these walls 48a, 48b defining therebetween an annular groove or channel 49 dimensioned to securely receive therein a portion of the cylindrical wall 38″ proximate the open end of the inner member 30a″.

To ensure sealing between the first 30a″ and second 30b′ inner member portions, sealing means such as, for example, an O-ring (not shown) may further be disposed inside the annular groove or channel 49.

Optionally, the first inner member portion 30a″ of the illustrated embodiment may, as shown, be characterized by a larger interior diameter 50 along a portion of the longitudinal length thereof proximate the open end, the length and diameter thereof corresponding to the longitudinal length and radial thickness of the interior wall 48b.

But while the foregoing embodiments depict an inner member comprising at least a two-part structure, it is contemplated that the inner member may be monolithic, formed, for instance, by blow molding. Alternatively, it is contemplated that the inner member may be comprised of more than two parts.

Referring again to FIGS. 1 and 2, the second inner member portion 30 will be seen to include a stem 35 extending from the end wall 42 thereof and arranged coaxial with the longitudinal axis of the housing 5. The stem 35 comprises a cylindrical member rotatably received in and extending through the passageway 9 of the second housing portion 5b. A fluid inlet passageway 34 defined through the stem 35 communicates a fluid from a fluid supply, to which the stem may be threadingly connected via threads 36, to the interior cavity 31 of the inner member.

With continuing reference to FIGS. 1 and 2 specifically, the first inner member portion 30a includes a mounting element (indicated generally at 51) provided on and extending from the end wall 41 via which mounting element the inner member is connected to a motor (not shown) extending through the motor mount 27 of the housing 5.

Of course, those skilled in the art will appreciate that various means may be employed to drive the selective rotational movement of the inner member 30, and that such means may be both arranged relative to the housing 5 and operatively coupled to the inner member 30 in numerous ways, depending upon such considerations as the type of means employed.

Referring now to FIGS. 1, 2 and 4, at least one outlet passageway 32 is provided through the cylindrical wall 34 of the first inner member portion 30a, such outlet passageway terminating in an outlet opening 33 to thus provide fluid communication between the interior cavity 31 and the exterior of the inner member 30. As shown in the exemplary embodiment, a plurality of such passageways 32 and outlet openings 33 are preferably provided, each passageway extending radially relative to the longitudinal axis of the inner member so as to terminate in outlet openings arranged about the circumference of the cylindrical wall 40. The particular arrangement of such passageways and outlet openings according to this embodiment is in a helical spiral relative to the longitudinal axis of the inner member 30. In this fashion, and as will be better understood from the remainder of this disclosure, the arrangement of passageways 32 and the corresponding outlet openings 33 permits selective, incremental rotational movement of the inner member 30 to selectively bring a single outlet opening 33 (and its associated outlet passageway 32) into communication with one of the plurality of outlet passageways 7 defined through the housing 5, thus permitting the selective communication of a fluid from the interior cavity 31 of the inner member 30 to the exterior of the housing 5 via the aligned outlet passageways 33 and 7.

With continuing reference to FIGS. 1, 2 and 4, each outlet opening 33 of the exemplary embodiment is defined in a raised projection 50 in the form of an annular bead or nipple projecting from the exterior surface of the cylindrical wall 40. Each such nipple is characterized by a radiused shoulder 51, best depicted in FIG. 4, to limit frictional contact between the outlet opening 33 and the internal surface of the housing wall 10, and to improve/promote sealing contact with the housing wall 10. But while so illustrated, it will be understood that this configuration of the projection 50 is not limiting of the present invention, and that such projection may take on any of numerous shapes subject only to the need for providing substantial sealing contact between the inner member 30 and the interior surface of the housing wall 10.

According to this embodiment, the outlet passageway 32 and associated opening 33 are, as shown, characterized by a relatively constant diameter, thus providing a constant velocity and volume of fluid flow from the inner member to the housing.

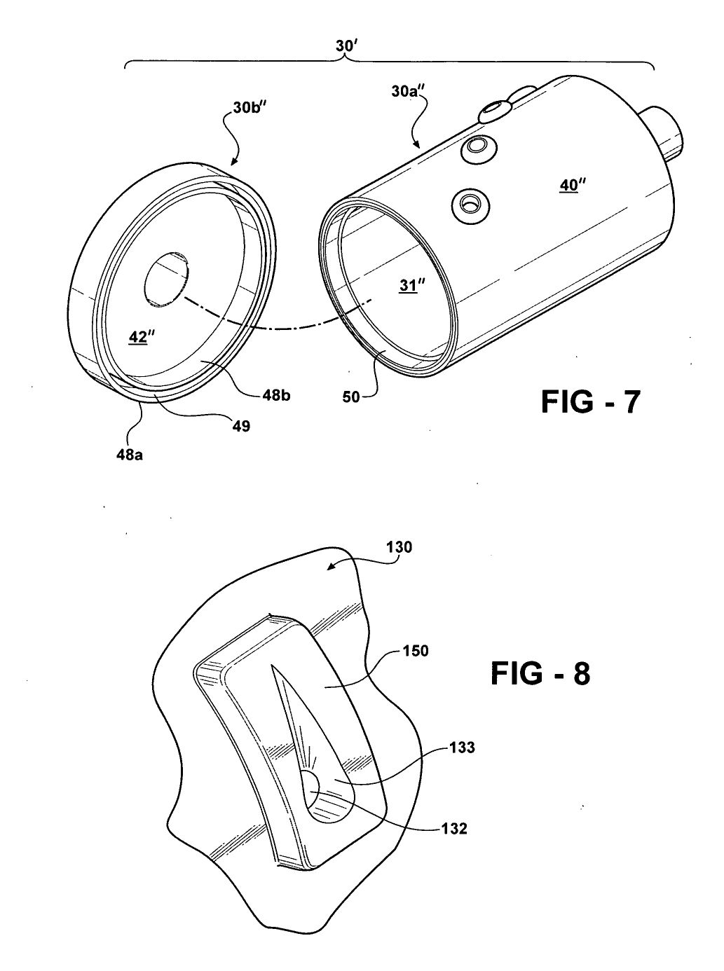

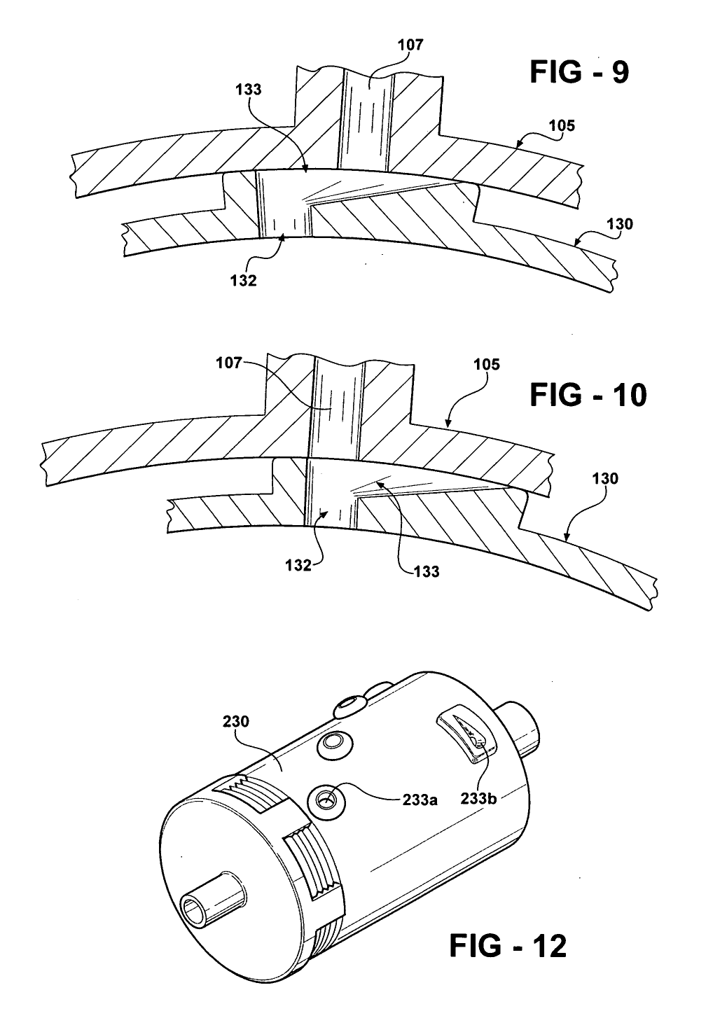

According to an alternative embodiment, shown in FIGS. 8 through 11, the at least one outlet passageway 132 terminates in a variably-dimensioned outlet opening 133 defined at least in part in a generally rectangularly-shaped raised projection 150 disposed on the exterior surface of the inner member 130. The projection 150 serves the same sealing function as the annular projection 50 described in the preceding embodiments, though is differently shaped to accommodate the larger geometry of the outlet opening 133. As particularly depicted, the outlet opening 133 is characterized by a tapered, “teardrop” plan shape, and further has a depth tapering downwardly from the upper surface of the projection 150. The outlet passageway 132, though shown disposed proximate the greater-dimensioned end of the outlet opening 133 in the illustrated embodiment, may be positioned anywhere along the length of the outlet opening. In providing such an outlet opening 133, it will be appreciated that the velocity of the fluid from the inner member 130 to the housing (not shown) may be varied, according to Bernoulli's Principle, by changing the relative orientation of the outlet passageway/outlet opening and the channel through the housing to thus change the relative dimensions of the outlet opening 133 at the point of transition between the outlet passageway 132 and the passageway 107 through the housing 105. This is illustrated best in FIGS. 9 and 10, which depict two of the possible relative orientations between an outlet passageway 132/opening 133 of the inner member 130 and the passageway 107 through the housing 105. According to the first position, shown in FIG. 9, the inner member 130 is oriented relative to the housing 105 so that the passageway 107 and the outlet passageway 132 are out of alignment, thereby forcing the fluid (not shown) through the constricted passage defined by the tapering dimensions of the outlet opening 133. In the second position, shown in FIG. 10, the inner member 130 is oriented relative to the housing 105 so that the outlet passageway 132 and passageway 107 are aligned, thus maintaining a relatively constant fluid-communication passage from the inner member through the housing. Of course, it will be understood by those skilled in the art that the foregoing depict just two possible relative orientations, and that the foregoing in fact permits a myriad of relative orientations between the inner member and housing so as to provide considerable adjustability in the velocity of fluid flow from the inner member through the housing and thence to whatever downstream elements may be provided for fluid actuation.

It will also be understood from the foregoing that the outlet opening 133 may be varied from that depicted in the above-described embodiment in order to tailor the variability of the flow rate as desired for a given application. Such variation in the configuration of the outlet openings may be in the two-dimensional and/or three-dimensional shape thereof. Thus, for instance, the length of the opening 133 may be extended to provide even greater variability in the rate of fluid flow between the inner member and the housing. Likewise, it will be understood that the variable-flow outlet openings as herein described may, in the alternative, be defined in the housing proximate the inlet to the outlet passageway therethrough, thereby essentially reversing the configuration of the illustrated embodiments. Finally, it will be understood that the variable-flow outlet openings as herein described may be defined in both the inner member and the housing to vary even more precisely the rate of fluid flow from the inner member to the housing. For instance, it is contemplated that in such an alternative construction the variable-flow outlet openings such as described herein would be defined in the housing and oriented so as to constitute mirror-images of the variable-flow outlet openings defined in the inner member.

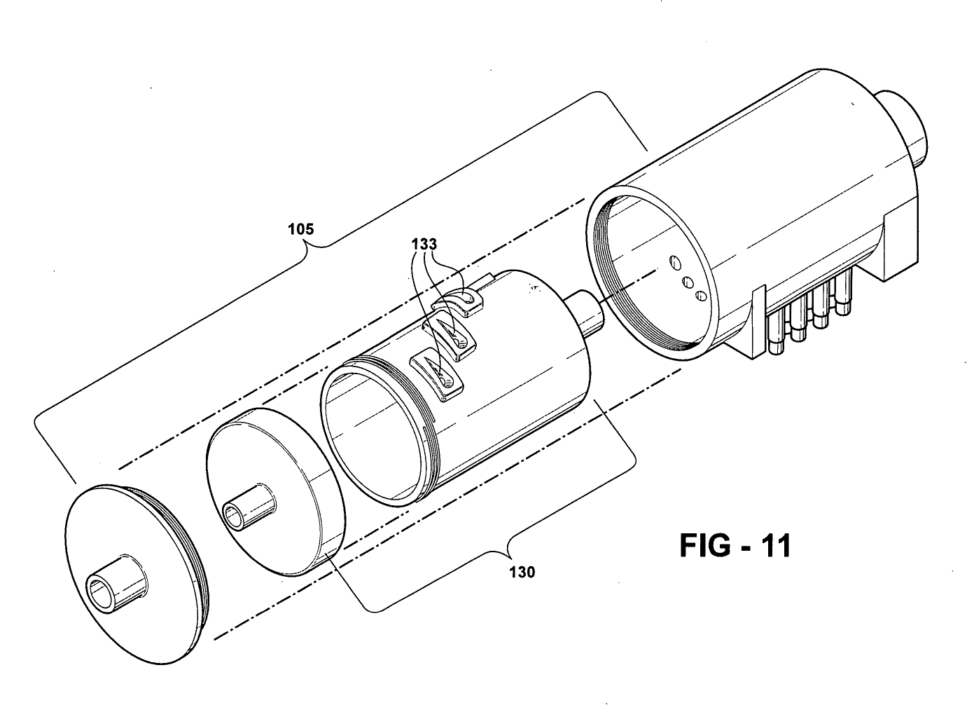

As depicted in FIG. 11, these variable-flow outlet openings 133 (and the associated passageways 132) may be arranged on the inner member 130 helically, as shown in the other embodiments of the invention heretofore described. Of course, the arrangements of the outlet openings and their associated outlet passageways shown and described is not meant to be limiting of the present invention. Those skilled in the art, having the benefit if this disclosure, will appreciate that multiple such arrangements are possible, according to the valve operations desired, without departing from the broader aspects of this invention.

It is also contemplated that the inventive valve may be designed so as to selectively bring into communication multiple sets of passageways in the interior member and the housing simultaneously. One such arrangement is shown in the alternative embodiment of FIG. 12, according to which the inner member 230 is provided with at least one pair of outlet openings 233a, 233b aligned along the longitudinal axis of the inner member 230, each such outlet opening having a corresponding passageway through the housing with which it may be selectively brought into alignment. As depicted, these outlet openings are of both the constant 233a and variable 233b embodiments described hereinabove, although it will be understood that any combination of such outlet openings may be provided. By this configuration, it will be understood that the inner member is capable of providing for the simultaneous porting of fluid through at least the two outlet openings as shown.

Also according to this invention, the inner member may elastically expandable radially outwardly under the pressure of a fluid contained in the inner member interior cavity so as to bring at least the one or more raised projections and associated outlet openings of the inner member into sealing contact with the interior surface of the housing wall under operating conditions. Without limitation, such elastic expandability may be imparted by fabricating at least the cylindrical wall of the inner member from a suitably elastic material such as, for example, a polymer, including, without limitation, polyamide, polyester, polyacetal, etc. It will be appreciated that metals and other materials may also be substituted for the foregoing exemplary polymers, subject only to the requirement that such alternative materials be characterized, through one or both of inherent material characteristics and construction, by sufficient elastic expandability as previously mentioned. The balance of the inner member, including the second inner member portion, may be fabricated from the same or another material, but is preferably characterized by a rigid construction relative to the cylindrical wall.

Referring specifically to FIG. 4, there is depicted a detailed view of the valve of the present invention wherein the interior cavity 31 of the inner member 30 is shown filled with a hydraulic fluid supplied through the housing 5 and inner member 30 from an external source (not illustrated), which fluid creates an internal pressure sufficient to urge the cylindrical wall 40 radially outwardly to bring the raised projection 50 into engagement with the interior surface of the housing 5 cylindrical wall 10.

As will be understood by those skilled in the art having the benefit of this disclosure, the acceptable frictional engagement between the raised projections 50 and the interior surface of the housing 5 cylindrical wall 10 will depend upon a number of factors, including the hydraulic fluid employed, the pressure created by the fluid within the inner member 30, the relative elasticity of the material employed in fabricating at least the cylindrical wall 40 of the inner member 30, and the size of the inner member 30.

Preferably, though not absolutely, the inventive valve is provided with means for reducing frictional engagement between the interior surface of the housing cylindrical wall and the one or more raised projections of the inner member under operating conditions—i.e., under conditions when cylindrical wall of the inner member is expanded radially outwardly by the pressure of a fluid contained within the interior space. According to one embodiment, such friction-reducing means comprise the provision of a fluid suspension in the circumferential space between the inner member 30 and housing 5. Such fluid-suspension may result from the purposeful design of the inner member 30 to create less than complete sealing engagement between the inner member 30 and the housing 5 under operating conditions, such that an amount of fluid just sufficient for lubricating the interior surface of the housing 5 cylindrical wall 10 and the outlet openings 32 of the inner member 30 is permitted to “leak” out from the outlet openings 32. In this fashion, the outlet openings 32 would effectively self-lubricate the associated raised projections 50.

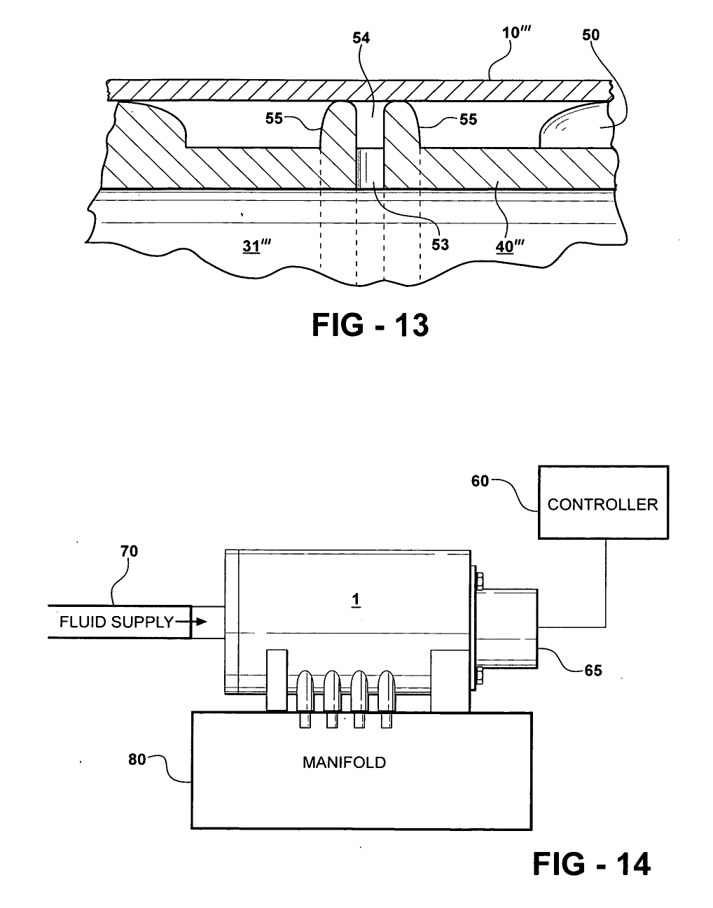

According to a further embodiment, shown in FIG. 13, the first inner member portion 30a″′ may be provided with one or more additional passageways 53 formed through the cylindrical wall 40″′ thereof, each such passageway 53 communicating fluid from the interior space 31″′ to a lubrication channel 54 defined on the exterior surface of the cylindrical wall 40″′ by a pair of spaced apart, parallel annular beads or rims 55 extending circumferentially about the cylindrical wall's exterior surface. These annular beads 55 may be spaced so as to also regulate the sealing pressure between the outlet openings and the interior wall of the housing.

Referring now to FIGS. 2, 4 and 14, operation of the present invention in one exemplary environment—wherein the valve 1 hereof is coupled to the remainder of an automatic transmission system, including a controller 60 responsive to signals from any of a variety of conventional data inputs, including, for instance, the throttle, the governor, output shaft torque, vehicle speed, etc., and operative to effect actuation of the motor 65 and selectively rotate the inner member, an hydraulic fluid supply 70 for the shift valve 1, and a manifold 80 communicating fluid from the shift valve 1 to activators for the clutches—will be better understood. More specifically, by operation of the motor 65 in response to the controller 60, the inner member of the shift valve 1 is selectively rotatably moved relative to the outer housing of the valve 1 by an angular distance which brings a desired one of the outlet openings 32 and its associated outlet passageway 33 into radial alignment with one of the plurality of radial outlet passageways 7 defined through the housing 5, thereby permitting communication of hydraulic fluid from the interior cavity 31 of the inner member 30 to the exterior of the housing 5 (and thence through an opening 81 in the manifold 80 to a selected one of the clutch activators) via the radially aligned passageways 7 and 33.

It will be appreciated, with reference being had to the foregoing disclosure, that the present invention provides an automatic transmission in which the shift valve thereof is at once relatively small and lightweight, and which requires less stringent tolerances between the operating components thereof as compared to prior art shift valves.

Of course, the foregoing is merely illustrative of the present invention, and those of ordinary skill in the art will appreciate that many additions and modifications to the present invention, as set out in this disclosure, are possible without departing from the spirit and broader aspects of this invention as defined in the appended claims.

The invention in which an exclusive property or privilege is claimed is defined as follows:

1. A valve for selectively porting a fluid through one or more outlets, the valve comprising:
a housing having an exterior, an interior cavity, and at least one outlet passageway defined through the housing, the outlet passageway communicating the interior cavity to the exterior of the housing through an outlet opening;
an inner member disposed within the interior cavity of the housing and selectively moveable relative thereto, the inner member having an exterior, an interior cavity for holding a fluid, and at least one outlet passageway defined through the inner member and communicating the interior cavity to the exterior of the inner member through an outlet opening;
at least one inlet passageway defined through each of the inner member and the housing for communicating a fluid from outside the housing to the interior cavity of the inner member; and
wherein, by selective movement of the inner member relative to the housing, the at least one outlet passageway and outlet opening of the inner member may be brought into communication with the at least one outlet passageway defined through the housing to thereby permit communication of a fluid from the interior cavity of the inner member to the exterior of the housing via the communicating outlet passageways.

2. The valve of claim 1, wherein the at least one outlet opening of the inner member is characterized by a varying geometry, and wherein further, by selective movement of the inner member relative to the housing, the at least one outlet opening of the inner member may be brought into communication with the at least one outlet passageway defined through the housing in a plurality of orientations, each of which permits a different rate of fluid flow from the interior cavity of the inner member to the exterior of the housing via the communicating outlet passageways.

3. The valve of claim 2, further comprising at least one raised projection on the exterior of the inner member, the at least one outlet opening of the inner member being defined in the at least one raised projection.

4. The valve of claim 3, wherein further the inner member is elastically expandable radially outwardly under the pressure of a fluid disposed in the inner member interior cavity so as to bring the at least one raised projection into sealing contact with the housing.

5. The valve of claim 1, wherein the at least one outlet opening of the inner member and the at least one outlet passageway of the inner member are characterized by generally constant geometries, and wherein further, by selective movement of the inner member relative to the housing, the at least one outlet opening of the inner member may be brought into communication with the at least one outlet passageway defined through the housing in single orientation which permits a relatively constant rate of fluid flow from the interior cavity of the inner member to the exterior of the housing via the communicating outlet passageways.

6. The valve of claim 5, further comprising at least one raised projection on the exterior of the inner member, the at least one outlet opening of the inner member being defined in the at least one raised projection.

7. The valve of claim 6, wherein further the inner member is elastically expandable radially outwardly under the pressure of a fluid disposed in the inner member interior cavity so as to bring the at least one raised projection into sealing contact with the housing.
